(19) United States
(12) Patent Application Publication
(10) Pub. No.: US 2013/0236002 A1
(43) Pub. Date: Sep. 12, 2013

(54) USING FACTOR ANALYSIS TO IMPROVE WORK ASSIGNMENT PERFORMANCE

(71) Applicants: Terry Don Jennings, Westminster, CO (US); Paul Roller Michaelis, Louisville, CO (US)

(72) Inventors: Terry Don Jennings, Westminster, CO (US); Paul Roller Michaelis, Louisville, CO (US)

(73) Assignee: AVAYA INC., Basking Ridge, NJ (US)

(21) Appl. No.: 13/414,930

(22) Filed: Mar. 8, 2012

(51) Int. Cl. H04M 3/00

(52) U.S. Cl. 379/265.12

(57) ABSTRACT

In the next generation contact center, a plethora of attributes may be used to describe incoming work requests as well as agents able to handle the work. A work assignment engine may have to sort through hundreds of combinations of attributes in order to identify the optimal or a close-to-optimal solution. One of the problems is how to process this amount of information quickly, as discussed above, at times on systems that do not have the computational horsepower to analyze complex data in a timely manner. This can create a tremendous, unmanageable computational burden for the contact center. One exemplary embodiment reduces the computational burden, and provides additional benefits, by employing a contact center-optimized extension of factor analysis techniques. In general, factor analysis is a statistical method used to describe variability among observed, correlated variables, e.g., attributes, in terms of a potentially lower number of unobserved, uncorrelated variables called factors.

### FIELD OF THE DISCLOSURE

An exemplary embodiment of the present disclosure is generally directed towards communications, and more specifically toward improving contact center efficiency.

### BACKGROUND

Contact routing (i.e., work assignment decision-making in a contact center or distributed contact center environment) is currently performed based on a comparison of agent skill to contact skill requirements. The agent skill is a single value (usually a scalar value ranging from 1 to 16) that represents a number of different factors including agent proficiency (often referred to as Key Performance Indicator (KPI) metrics, which can include First Call Resolution (FCR), CSS, $/call, $/min, Profit/call, Profit/min, Average Handle Time (AHT), Abandon Rate, closure rate, quality score, commit to pay rate, revenue/target, etc.), agent preference, and other subjective criteria.

Unfortunately, an agent's skill level is a grossly simplified representation of the agent's ability to actually handle a contact having certain processing requirements. Another unfortunate reality is that agent skill level is often subject to the opinions of their supervisors (which may or may not accurately reflect the agent's true ability to handle contacts of a certain type).

The reason, however, that agent skill is used as the basis for making work assignment decisions is that if more detailed metrics (e.g., the actual KPI metrics) were used for making such decisions, the processing overhead would be enormous and contact centers would either be more expensive to implement or more difficult to maintain. In particular, routing based on actual KPI metrics would not be feasible in contact centers that employ traditional skill-based routing paradigms (e.g., skill-based queues).

In particular, contact centers typically make routing decisions based on agent skill level (an abstraction of true agent capabilities). There is no currently-available contact center solution that allows real-time KPI metrics to be used for making routing decisions.

In addition to the above, the expense of manually administering a contact center is already substantially high. Especially for larger contact centers having thousands of agents and many skill levels, it is practically infeasible to manually administer skill changes (because there have been minor changes in KPI metrics) on a regular basis. Specifically, if a large contact center having 10,000 agents with each agent having multiple skills (e.g., 16) were tasked with changing only 1% of skills on a weekly basis (due to KPIs changing), there would have to be approximately 1600 manual skill changes every week. This is a primary reason why many large contact centers do not update skill levels for agents every time the agent's KPI changes slightly.

It is with respect to the above issues and other problems solutions have been developed where an analytics engine works in conjunction with a work assignment engine. In some solutions, the analytics engine monitors or receives, in real-time, agent performance information and determines real-time KPI metrics for all resources/agents in the contact center. The analytics engine then selects which of the real-time KPI metrics are to be selected (based on goals or business rules) as matching parameters to be used by the work assignment engine. As one example, if business rules or goals dictate that profit/call should be highly regarded (e.g., because it is the end of the fiscal year) then the KPI metrics which maximize profit/call can be selected by the analytics engine and then provided to the work assignment engine to route on. Conversely, if business goals change to focus on customer satisfaction or minimized wait time, then the analytics engine can select different KPI metrics to provide to the work assignment engine.

In some solutions, the analytics engine may also be configured to normalize some or all KPI metrics based on how far the current KPI metric is from the goal for that metric (e.g., current KPI metric above or below target KPI metric and by how much). This normalized KPI metric may be the actual value provided to the work assignment engine as the matching parameters. The work assignment engine can then calculate a routing score for the KPI metrics based on a weighted average for the normalized KPI metrics, which can be used for making the work assignment decision.

In some other solutions, the technology which enables routing decisions based on a plurality of KPI metrics (real-time and/or non-real-time) rather than a single skill value is the concept of a next generation contact center that does not solely rely on skill-based routing or the notion of queues. Examples of such contact centers are described in further detail in U.S. patent application Ser. No. 12/882,950 to Flockhart et al., the entire contents of which are hereby incorporated herein by reference. Specifically, bitmaps and masks (calculated based on the KPI metrics received from the analytics engine) can be utilized for making the routing decision.

These systems can also include the capability to dynamically change what KPI metric(s) is/are used in real-time based on changing conditions of the contact center or a change in focus of the contact center administrator. These changes can be made easily without altering the core of the routing engine logic.

KPIs may include, without limitation, any metric or combination of metrics that define performance of an entity within a contact center (e.g., a contact center agent, a group of contact center agents, etc.). Specifically, a KPI can be defined in terms of making progress toward strategic goals or simply the repeated achievement of some level of an operational goal.

In a contact center context, KPIs may vary depending upon whether work items correspond to outbound contacts (e.g., contacts originated by the contact center) or inbound contacts (e.g., contacts received at the contact center that have been originated outside the contact center). Non-limiting examples of outbound contact KPIs include: Contacts per hour—Average number of customers a call center agent was able to contact within an hour; Leads Conversion Rate—The percentage of leads that actually converted to sales; Hourly Sales—The average amount of sales the call center representative was able to close in an hour; Daily Sales—The average value of sales the agent was able to close in a day; and Accuracy—Extent to which a contact has been handled according to a predetermined script.

Non-limiting examples of inbound contact KPIs include: Real time Q—Metrics; Calls per hour—The average number of calls the agent is able to take per hour; Saves/One-Call Resolutions—The number of times our agents are able to resolve an issue immediately within the first phone call. Colloquially referred to as “one-and-done” calls; Average Handle Time—How long it takes for one call to be handled, which includes the call time itself, plus the work done after that call; Average Wait Time—How long a caller is put on hold before a call center agent becomes available to take the call; Accuracy; Abandonment Rate—This is the percentage of customers who disconnected before an agent was able to intercept the call; and Completion Rate—The ratio of successfully finished calls to the number of attempted calls by the customer.

Other types of KPIs that are not necessarily specific to inbound or outbound contacts include, without limitation, customer satisfaction level, customer service level, average speed of answer, contact forecast precision level, quality of services rendered, average handling cost of a contact, agent occupancy ratio, schedule adherence and conformity, and time distribution (in service, non-service detailed time or “shrinkage”). Other examples include number of times calls are put on hold, number of transfers, $/min, $/call, number of upsells, number of crosssells, etc.

### SUMMARY

In the next generation contact center, a plethora of attributes may be used to describe incoming work requests as well as agents able to handle the work. A work assignment engine may have to sort through hundreds of combinations of attributes in order to identify the optimal or a close-to-optimal solution. One of the problems is how to process this amount of information quickly, as discussed above, at times on systems that do not have the computational horsepower to analyse complex data in a timely manner.

As eluded to above, contact centers may track well over 100 different measures of agent performance. This can create a tremendous, unmanageable computational burden for the contact center. One exemplary embodiment reduces the computational burden, and provides additional benefits, by employing a contact center-optimized extension of factor analysis techniques. In general, factor analysis is a statistical method used to describe variability among observed, correlated variables, e.g., attributes, in terms of a potentially lower number of unobserved, uncorrelated variables called factors. In other words, it is possible, for example, that variations in three or four observed variables mainly reflect the variations in fewer such unobserved variables. Factor analysis searches for such joint variations in response to unobserved latent variables. The observed variables are modeled as linear combinations of the potential factors, plus “error” terms. The information gained about the interdependencies between observed variables can be used later to reduce the set of variables in a data set. Computationally, this technique is equivalent to low rank approximation of the matrix of observed variables. See http://en.wikipedia(dot)org/wiki/Factor_analysis for additional details and statistical models that define factor analysis.

One of the fundamental underlying ideas is that if one can identify the correlation clusters that exist among the factors being tracked—i.e., if one can identify the extent to which the scores of every factor correlate with the scores of every other factor—it is possible to group the individual factors into clusters such that the scores of the factors within each cluster are correlated with each other, but largely independent of the scores in other clusters. For example, when this type of analysis is performed on the scores achieved by a large population of students taking a multi-question SAT math test, correlation clusters emerge that are commonly interpreted to correspond to “algebraic aptitude” and “geometric aptitude.”

With regard to how an extension of this technique may be used in contact centers: If one is able to determine that the score of two or more factors are highly correlated, and largely uncorrelated with other factors, acceptable predicted validity can be achieved more quickly and with much lower computational complexity by tracking just one of the factors in that group. If this concept is extended to a contact center work assignment engine, the number of attributes considered for work assignment decisions can be reduced without significant loss of predictive accuracy, thereby reducing computational burden while improving contact center speed and efficiency.

The underlying statistical techniques disclosed herein are employed in order to improve the efficiency of contact centers. The disclosed techniques may be conducted in real-time, or on historical data, and may be conducted on equipment co-located with the contact center and/or on off-site servers.

In accordance with one exemplary embodiment, a benefit of the proposed statistical procedure is that it will be possible to create equations along the lines of [performance]=[score on factor A times weighing of factor A]+[score on factor B times weighing of factor B]. . . +[score on factor Z times weighing of factor Z].

This can allow the contact center to identify and concentrate on the important factors, and stop tracking factors in clusters that do not contribute significantly to the accurate prediction of performance. Identification of which factors and clusters would be regarded as above a threshold, and which would be below the threshold, would be determined by the contact center.

One exemplary embodiment could include a simulation tool that allows measures such as predictive accuracy, complexity of the computation, and speed of the computation to be approximated as factors and clusters are added to, or removed from, the equation.

Another exemplary implementation of the analysis tool would allow users to vary the strength of the correlation that determines whether factors should be regarded as clusterable. An exemplary enhancement would include a simulation tool that allows measures such as predictive accuracy, complexity of the computation, and speed of the computation to be approximated as the cluster-defining correlation strength is varied.

A contact center that is able to identify the independent factors that correlate highly with performance can, in theory, do a better job targeting ways to improve their efficiency—for example, by targeting these factors, they could do a better job training their agents, assigning agents to different specialties, and knowing what to look for when interviewing and testing candidates for agent positions.

In contact centers that have busy periods and periods in which their computational resources are underutilized, an exemplary embodiment could be scheduled to conduct the complex factor analysis on recently acquired data during periods when resources are available, thereby allowing the contact center to use recent data to make optimal assignment decisions for an upcoming busy period. This technique would also allow the contact center to discover and track changes that occur over time.

It is likely that different contact centers will have different correlational clusters, depending on factors such as the nature of the contact center (for example, a sales oriented contact center, a government information contact center, etc.), its geographic location (e.g., India vs. US), time of day, and time of year. Similarly, the predicted value of each cluster or the individual factor or attribute that is considered to be representative of the cluster—e.g., the factor weights described above—can be expected to vary. In this context, it is important to recognize that even if contact centers do not use the proposed techniques to analyze their databases or make work assignments, it would be useful for the manufacturers and vendors of contact center equipment to know the different statistically independent factors and different factor weights that may be present at the different types of contact centers that buy the equipment.

Illustratively, if manufacturers and/or vendors were able to acquire data from active contact centers, analysis of the sort described herein could improve revenue opportunities for the sale of new equipment by allowing the configurations that are proposed by sales personnel to be customized and optimized for each contact center's environment and needs. Exemplary implementation of this concept could include the proposed techniques as an adjunct to sales support configurations.

Accordingly, one exemplary aspect is directed toward the use of a reduced factor set rather than a large attribute set thereby reducing the cost of making work assignments and improving throughput in a next generation contact center.

Another exemplary aspect is directed toward the use of contact center-adjustable correlational cluster analysis techniques to reduce the cost, time, and computational complexity required to make optimal or close-to optimal work assignments in real-time, near real-time, and/or even off-line.

As discussed, one exemplary aspect is directed toward systems and methods that are capable of more efficiently tracking very large quantities of attributes in a call center environment. As discussed, some attributes that are measured are actually related to and directly correlatable to other attributes, metrics and/or factors. These correlatable quantities can be clustered, with a variable representing the cluster being usable to track the group of attributes in the cluster. For example, assume the system has 12 attributes that it is tracking or measuring, but all these attributes are measures for a same or comparable trait. Assuming these attributes are correlatable, they can be grouped into one cluster with the call center only needing to track a variable representing the cluster as opposed to each of the 12 specific attributes.

Additional exemplary aspects relate to determining one or more clusters into which various attributes may be grouped, updating these clusters on, for example, a predetermined basis assuming that the clusters may need to be dynamically updated as attributes fall into and out of correlation, optionally assigning a weight to the one or more determined clusters and using, for example, information representing each of the clusters for determining one or more of call routing, as a metric to be used in assessing performance, or in general for any technique, measure or function within the call center environment normally occur with the individual attributes.

Another exemplary aspect is directed toward dynamically changing cluster definitions based on how correlatable the attributes within the cluster are. Moreover, more than one variable or attribute can be used to represent a correlated cluster. For example, and for a highly correlated cluster, the system could use one attribute to track and define that highly correlated cluster. For a less highly correlated cluster, the system could use for example two attributes. And for an even less highly correlated cluster, the system could check on a more frequent basis the degree of correlatedness between the attributes and dynamically introduce or remove one or more attributes from the cluster based on this degree of correlatedness.

Another exemplary aspect is directed toward being able to have a templated set of clusters that may be universally applicable to one or more types of call center environments. For example, for call centers that handle product sales, a certain set of templated clusters may be able to be shared between different call center clients. Similarly, a set of templated clusters may be able to be used between different call center clients where the call centers both handle computer troubleshooting.

In accordance with another exemplary embodiment, one attribute of a cluster of highly correlatable attributes can be used as input to the work assignment engine. As an alternative, and for correlatable attributes that have a similar velocity but a different displacement, the system can automatically update and normalize the value that is input to the work assignment engine to compensate for the fact that highly correlatable attributes could have grossly different displacements, but a similar velocity, with similar correlatability.

The information that represents not only the identifier of the cluster, but which attributes are clusterable, scoring information, etc., which attribute to use as input to, for example, the work assignment engine, and in general any cluster information, can be made available to the work assignment mechanism itself

In accordance with another exemplary aspect, the manufacturer or vendor of the contact center could be queried for feedback as to which specific attributes are more important than others, which could assist with determining how clusters are assembled, how to weight clusters, which attribute to use as representative of a highly correlated cluster, and the like.

In accordance with another exemplary embodiment the system identifies clusters and can identify one or more clusters as highly useful clusters that can assist with, for example, the extent that performance is affected by a particular cluster. The system can then identify one or more attributes in the cluster and ignore the other attributes in the cluster or other attributes that correlate highly to a specific attribute. This identified attribute can therefore be the only attribute that is measured in the cluster with that attribute being usable to effect engine work assignments. Furthermore, once a cluster is identified as highly relevant, the system can automatically adjust one or more of tuning, weighting, and clustering such that, for example, more important attributes have the greatest impact and can be used as input to the work assignment mechanism.

In accordance with yet another exemplary embodiment, a predictive or simulation tool can be provided that predicts performance of call center scores. For example, the predictive tool can provide feedback indicating which one or more attributes may be needed for a particular environment. This could, for example, make it easier to match customers, agents, resources, attributes and/or clusters.

As will further be appreciated, not only the attributes, but the grouping of correlated attributes into clusters can be dependent on the nature of the traffic received in a particular call or contact center. Based on this, the clusters can be continuously and dynamically updated, as, for example, traffic into a call or contact center changes.

In accordance with another exemplary embodiment, systems and techniques used herein can be used in queued contact center environments, as well as queueless contact center environments. In queued contact center environments, the solutions disclosed herein may help reduce the number of queues in the contact center.

In accordance with another exemplary aspect, results of factor analysis are provided back to a vendor of contact center equipment, thereby allowing the vendor to adjust configurations of equipment offered to those contact centers and to other centers that support similar customer bases. One exemplary benefit of this approach is that the fine-grained analyses performed by many contact centers might be regarded by them as a proprietary process. The factor analysis reporting, without describing the individual metrics, would help protect the contact center's proprietary techniques.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible non-transitory storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE FIGURES

The present disclosure is described in conjunction with the appended figures:

FIG. 1 is a block diagram of a communication system in accordance with embodiments of the present disclosure;

FIG. 2 is a block diagram depicting pools and bitmaps that are utilized in accordance with embodiments of the present disclosure;

FIG. 3 illustrates one exemplary relationship between attributes and clusters; and

FIG. 4 illustrates an exemplary method for managing clusters and attributes.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

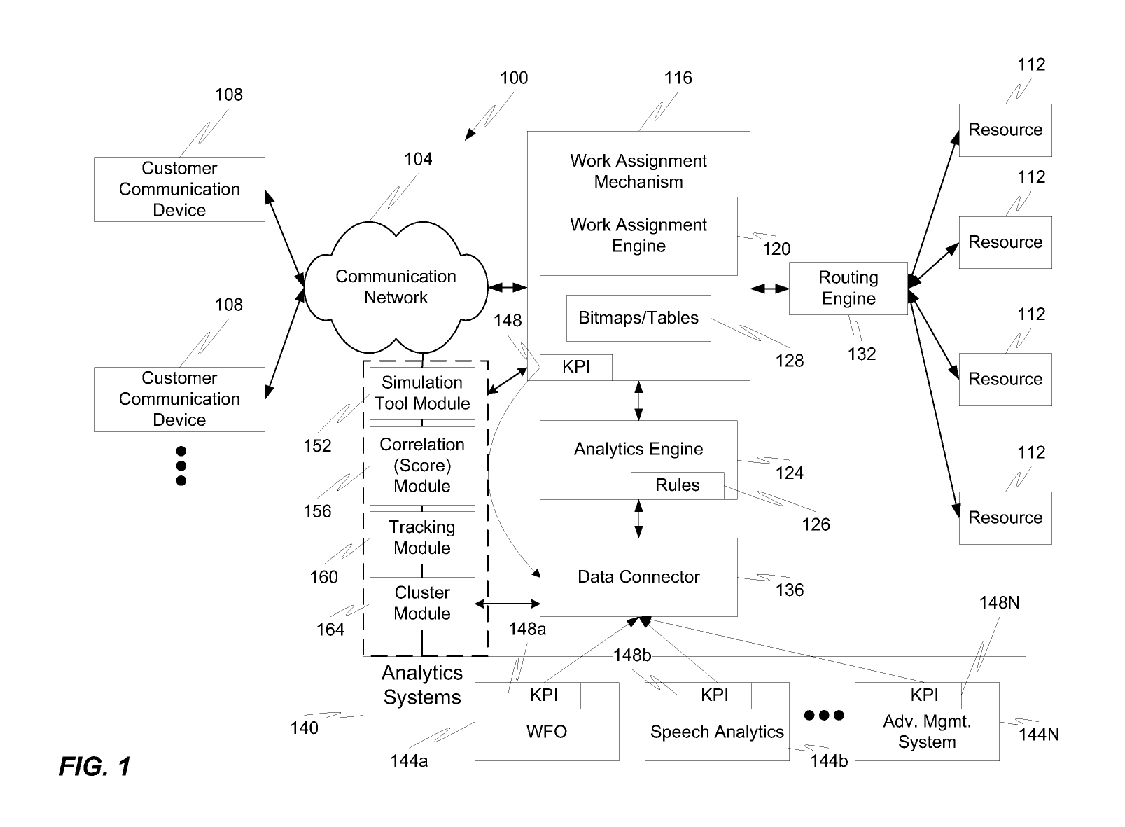

FIG. 1 shows an illustrative embodiment of a communication system 100 in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from the customer communication devices 108.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network comprising many computers, computing networks, and other communication devices located, for example, all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are incorporated herein by reference. Moreover, the communication network 104 may comprise a number of different communication media such as coaxial cable, copper cable/wire, fiber-optic cable, antennas for transmitting/receiving wireless messages, and combinations thereof

The communication devices 108 may correspond to customer communication devices. In accordance with at least some embodiments of the present disclosure, a customer may utilize their communication device 108 to initiate a work item, which is generally a request for a processing resource 112. Exemplary work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax and combinations thereof.

In some embodiments, the communication may not necessarily be directed at the work assignment mechanism 116, but rather may be on some other server in the communication network 104 where it is harvested by the work assignment mechanism 116, which generates a work item for the harvested communication. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 1010, Feb. 17, 2010, and Feb. 17, 2010, respectively, each of which are hereby incorporated herein by reference in their entirety.

The format of the work item may depend upon the capabilities of the communication device 108 and the format of the communication. In particular, work items are logical representations within a contact center of work to be performed in connection with servicing a communication received at the contact center (and more specifically the work assignment mechanism 116). The communication may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 132 to connect the communication device 108 which initiated the communication with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference.

More specifically, the work assignment engine 120 can generated bitmaps/tables 128 and determine, based on an analysis of the bitmaps/tables 128, which of the plurality of processing resources 112 is eligible and/or qualified to receive the work item and further determine which of the plurality of processing resources 112 is best suited to handle the processing needs of the work item. In situations of work item surplus, the work assignment engine 120 can also make the opposite determination (i.e., determine optimal assignment of a work item to a resource). In some embodiments, the work assignment engine 120 is configured to achieve true one-to-one matching by utilizing the bitmaps/tables 128 and any other similar type of data structure, such as an attribute representing a cluster.

The work assignment engine 120 may reside in the work assignment mechanism 116 or in a number of different servers and/or processing devices. In some embodiments, cloud-based computing architectures can be employed whereby one or more components of the work assignment mechanism 116 are made available in a cloud or network such that they can be shared resources among a plurality of different users.

In addition to comprising the work assignment engine 120, the system 100 may also comprise an analytics engine 124 and one or more bitmaps/tables 128. The analytics engine 124 and/or bitmaps/tables 128 may be internal to the work assignment mechanism 116 or they may be separate from the work assignment mechanism 116. The analytics system can also comprise a simulation tool module 152, a correlation (scoring) module 165, a tracking module 160 and a cluster module 164. In some embodiments, the analytics engine 124 may be configured to receive or collect a plurality of real-time data inputs from various analytics systems 140 and/or an input(s) representing a cluster(s) from the cluster module 164 that are internal to the contact center or external to the contact center.

In some embodiments, there is a data connector 136 residing between the analytics engine 124, cluster module and analytics systems 140. The data connector 136 may be configured to retrieve, on a predetermined basis, KPIs 148a-N from the analytics systems 140 and/or information representing a cluster that can represent one or more correlatable KPIs. Specifically, the analytics systems 140 may comprise a number of specific analytic tools that analyze various different performance aspects of the resources 112 and generate KPIs 148a-N based on their analysis of the resource 112 performance.

Although three analytics tools are shown in the analytics systems 140, it should be appreciated that a greater or lesser number of analytics tools may be used to generate KPIs 144, 148 that are harvested by the data connector 136 and eventually sent to the analytics engine 124. Some non-limiting examples of analytics tools that may be included in the analytics systems 140 are a Work Force Optimizer (WFO), a speech analytics tool, a video analytics tool, a context analytics tool, advanced management information systems, or any other analytics tools known in the contact center arts.

The data connector 136 may also be adapted to collect KPIs 148 that are generated by the work assignment mechanism 116 and/or cluster module 164. Examples of KPIs 148 that are generated by the work assignment mechanism 116 (or specifically the work assignment engine 120) include, but are not limited to, occupancy, handle time, and idle time statistics for the resources 112. Of course, one or more of these KPIs 148 may be generated by an analytics tool in the analytics systems 140.

As discussed above, the data connector 136 may be configured to harvest or pull KPI data from the analytics systems 140 on a predetermined basis (e.g., every second, ten seconds, minute, half-hour, hour, day, week, month, etc.) and provide the collected KPI data to the analytics engine 124. The length of the predetermined basis can be altered by the work assignment engine 120 and/or analytics engine 124 or it may be manually administered.

In some embodiments, each analytics tool may be configured to generate its own set of KPIs. It may be possible that multiple instances of some KPIs are generated by different analytics tools. If this is the case, the data connector 136 may be configured to normalize the multiple instances of the KPIs from the different sources, aggregate the multiple instances of KPIs from the different sources, or otherwise combine the multiple instances of KPIs from the different sources before such information is provided to the analytics engine 124. It may also be possible that the data connector 136 simply aggregates the data from each of the analytics tools and forwards it on the analytics engine 124 which is configured to sort or manipulate the KPIs as needed.

In some embodiments, the KPIs and/or cluster information that are retrieved at the data connector 136 and provided to the analytics engine 124 describe the current operating conditions of the contact center. The analytics engine 124 may utilize the inputs and one or more business rules 126 that define desired operating goals of the contact center to select one or more real-time KPIs. The selected one or more KPIs and/or information representing correlated, clustered information (e.g., a subset of the KPIs received from the data connector 136) may then be provided to the work assignment engine 120. The work assignment engine 120 can then utilize the KPIs and/or information representing correlated, clustered information received from the analytics engine 124, the bitmaps/tables 128 and/or cluster module 164 to make a work item assignment decision. In particular, the work assignment engine 120 may use one or more of the information representing correlated, clustered attributes and the KPIs received from the analytics engine 124 as routing parameters. The information representing correlated, clustered attributes and/or KPIs, as routing parameters, can be used to build one or more bitmaps/tables 128 that will eventually cause a work item to be assigned to a resource 112.

As noted above, the analytics engine 124, or portions thereof, may be implemented in the routing engine 132 or some other separate server or switch that is connected to the work assignment mechanism 116. It may also be possible to implement multiple analytics engines 124 at different locations in the contact center. Likewise, the data connector 136 or any other component not depicted as being incorporated into the work assignment mechanism 116 may be incorporated in the work assignment mechanism without departing from the scope of the present disclosure. Additionally, the functions performed by any of the components of the system 100 may be performed by other components without departing from the scope of the present disclosure. As a non-limiting example, the functions of the data connector 136 may be implemented by the analytics engine 124.

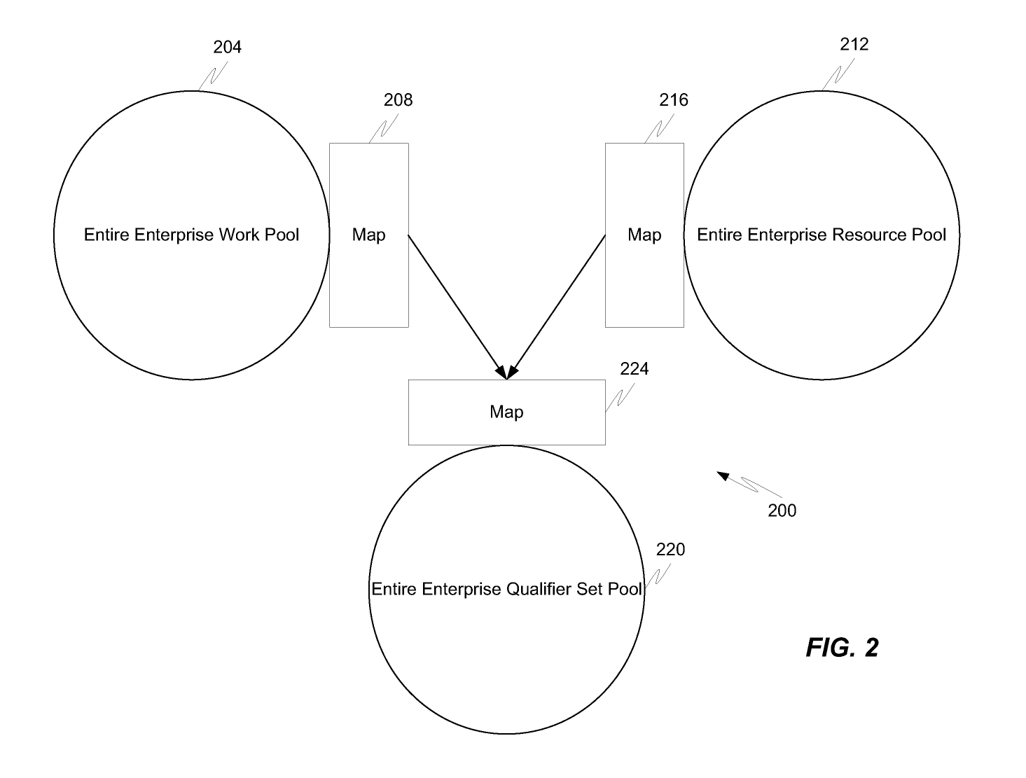

FIG. 2 depicts exemplary data structures 200 which may be incorporated in or used to generate the bitmaps/tables 128 used by the work assignment engine 120. The exemplary data structures 200 include one or more pools of related items. In some embodiments, three pools of items are provided, including an enterprise work pool 204, an enterprise resource pool 212, and an enterprise qualifier set pool 220. The pools are generally an unordered collection of like items existing within the contact center. Thus, the enterprise work pool 204 comprises a data entry or data instance for each work item within the contact center.

In some embodiments, the population of the work pool 204 may be limited to work items waiting for service by a resource 112, but such a limitation does not necessarily need to be imposed. Rather, the work pool 204 may contain data instances for all work items in the contact center regardless of whether such work items are currently assigned and being serviced by a resource 112 or not. The differentiation between whether a work item is being serviced (i.e., is assigned to a resource 112) may simply be accounted for by altering a bit value in that work item's data instance. Alteration of such a bit value may result in the work item being disqualified for further assignment to another resource 112 unless and until that particular bit value is changed back to a value representing the fact that the work item is not assigned to a resource 112, thereby making that resource 112 eligible to receive another work item.

Similar to the work pool 204, the resource pool 212 comprises a data entry or data instance for each resource 112 within the contact center. Thus, resources 112 may be accounted for in the resource pool 212 even if the resource 112 is ineligible due to its unavailability because it is assigned to a work item or because a human agent is not logged-in. The ineligibility of a resource 112 may be reflected in one or more bit values.

The qualifier set pool 220 comprises a data entry or data instance for each qualifier set within the contact center. In some embodiments, the qualifier sets within the contact center are determined based upon the attributes or attribute combinations of the work items in the work pool 204. Qualifier sets generally represent a specific combination of attributes for a work item. In particular, qualifier sets can represent the processing criteria for a work item and the specific combination of those criteria. Each qualifier set may have a corresponding qualifier set identified “qualifier set ID” which is used for mapping purposes. As an example, one work item may have attributes of language=French and intent=Service and this combination of attributes may be assigned a qualifier set ID of “12” whereas an attribute combination of language=English and intent=Sales has a qualifier set ID of “13.” The qualifier set IDs and the corresponding attribute combinations for all qualifier sets in the contact center may be stored as data structures or data instances in the qualifier set pool 220.

In some embodiments, one, some, or all of the pools may have a corresponding bitmap. Thus, a contact center may have at any instance of time a work bitmap 208, a resource bitmap 216, and a qualifier set bitmap 224. In particular, these bitmaps may correspond to qualification bitmaps which have one bit for each entry. Thus, each work item in the work pool 204 would have a corresponding bit in the work bitmap 208, each resource 112 in the resource pool 212 would have a corresponding bit in the resource bitmap 216, and each qualifier set in the qualifier set pool 220 may have a corresponding bit in the qualifier set bitmap 224.

In some embodiments, the bitmaps are utilized to speed up complex scans of the pools and help the work assignment engine 120 make an optimal work item/resource assignment decision based on the current state of each pool. Accordingly, the values in the bitmaps 208, 216, 224 may be recalculated each time the state of a pool changes (e.g., when a work item surplus is detected, when a resource surplus is detected, and/or when new KPIs are provided from the analytics engine 124 to the work assignment engine 120).

Furthermore, the values of the qualifier set bitmap 224 may be dynamically changed by the work assignment engine 120. In particular, the qualifier set bitmap 224 may be dynamically changed during contact center operations based on the different KPIs that are provided from the analytics engine 124 to the work assignment engine 120. As the qualifier set bitmap 224 is altered, the parameters/attributes that define how work items should be assigned to resources 112 will also vary.

Any information in the data structures 200, or in general any attribute, variable, quantity and/or value in the communications system 100, e.g., KPIs, bitmaps/tables, etc., may be correlated with another one or more of the attributes, variables, quantities and/or values. As discussed, portions of this information can be clustered. A variable representing each cluster can then be used as input to any process in the communications system 100 rather than each separate variable, attribute, etc. This can greatly increase efficiencies as discussed above.

Contributing to the generation, management and tracking of clusters is the simulation tool module 152, correlation module 156, tracking module 160 and cluster module 164.

The simulation tool module 152 allows an entity, such as a contact center, to identify and concentrate on the important factors, and stop tracking factors and clusters that do not necessarily contribute significantly to the accurate prediction of performance, or assist with call routing, or the like. The identification of which factors and clusters and the assignment of a corresponding “correlation” threshold can be determined by the simulation tool module 152. The simulation tool module can also assist with predictive accuracy, determining a reduction in the complexity of the computation, and assessing the speed of the computation(s) to be performed as clusters and factors are added to, or removed from, the equation as discussed above. The simulation tool module 152 allows a user to one or more of assign and vary the strength or “closeness” of the correlation which, when assigned by the correlation module 156, is used by the cluster module 164 to group information identified as being clusterable.

More specifically, any one of more of the attributes, variables, quantities, etc. are analyzed by the correlation module 156 and assigned a score based on the relative degree of correlation to one or more of the other attributes, variables, etc. The system, based on a threshold, and in cooperation with the cluster module 164, is then able to cluster the correlatable information that falls within the set threshold or range. As discussed, information regarding the one or more established clusters can be forwarded to, for example, the work assignment mechanism 116 such that the work assignment mechanism 116 is aware of which information has been grouped into the cluster. Similarly, the cluster information can be forwarded to the analytics systems 140 for use with any of the analytics discussed herein.

It should be appreciated that clusters established by the cluster module 164 are not necessarily static, as information contained therein could vary and become uncorrelated as the environment within the communications system 100 changes. Therefore, the tracking module 160 provides the ability to dynamically track information that has been clustered, to ensure the clustered information is remaining correlated in accordance with the assigned threshold or range.

Tracking module 160 is therefore provided with the ability to add or remove attributes, variables, etc. from a cluster based on the correlatedness, or uncorrelatedness, of that particular attribute, variable, etc. to the other attributes, variables, etc. The frequency with which this can be performed can be proportional to, for example, the relative degree of importance assigned to a particular cluster, the frequency with which the attributes, variables, etc., within the cluster change, based on user defined rules, or some combination thereof. Other factors that can contribute to how frequently the tracking module 160 reassesses correlatedness in one or more of the defined clusters can include, but are not limited to, work load of the work assignment mechanism 116, availability or unavailability of resources, and in general any performance metric associated with the communications system 100.

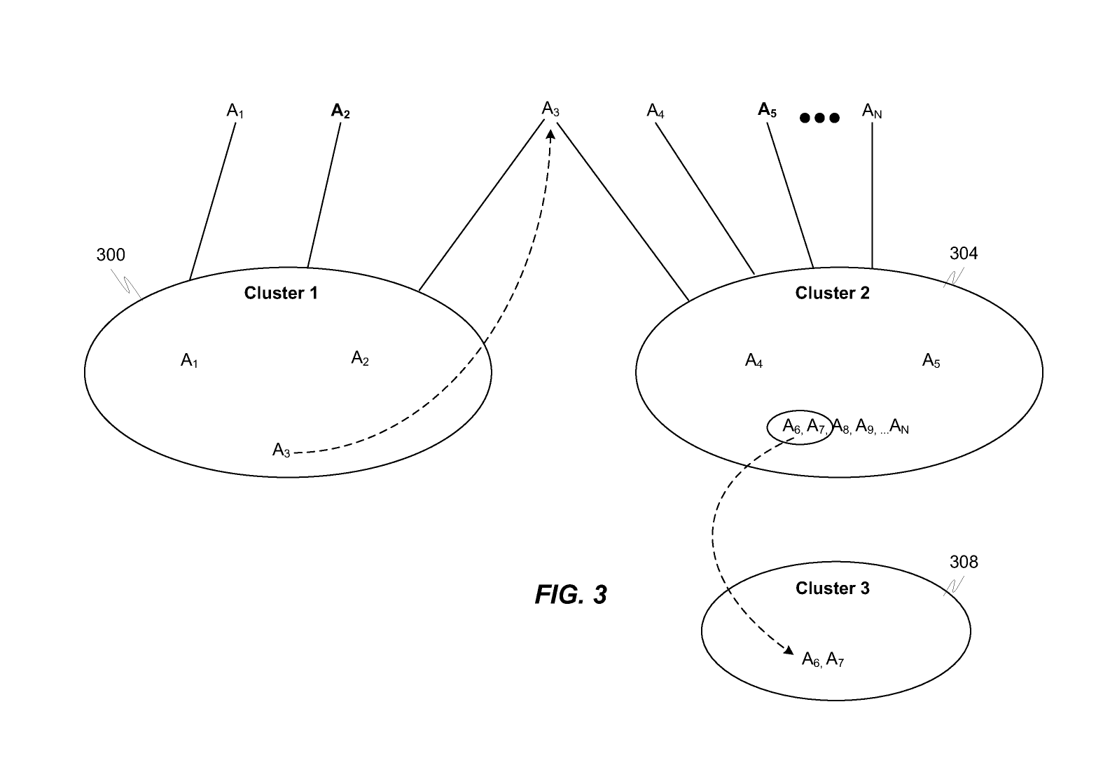

As illustrated in FIG. 3, correlation module 156 has identified attributes that have a particular degree of correlation. The cluster module 164 has then determined that certain attributes should be grouped in cluster 1 300 and other attributes grouped in cluster 2 304.

More specifically, and in accordance with one exemplary embodiment, cluster 1 includes attributes A1 and A2, and initially includes attribute A3. Cluster 2 includes attribute A4, A5 . . . AN. The association and clustering of these attributes was based on a particular degree of correlation therebetween with, for this exemplary embodiment, attribute A2 representing cluster 1 and attribute AS representing cluster 2. As discussed, since the clustered attributes may have similar velocities but different displacements, the attributes selected for representing the cluster could be appropriately scaled or normalized as needed. a. Here, attribute A3 is initially included in cluster 1 300. However, at a later point in time, the tracking module 160 determines that A3 is becoming uncorrelated relative to attribute A1 and A2. Therefore, the tracking module 160, cooperating with the cluster module 164, can remove attribute A3 from cluster 1 at which point attribute A3 becomes an independent, stand-alone attribute not included in any particular cluster. This process of adding and removing attributes from clusters, as well as the creation of new clusters, can occur dynamically and at any point in time and/or manually, for example, as requested by a user.

The correlation module 156 can assign different scores or thresholds to different clusters. For example, cluster 1 300 could be assigned a first threshold for which the included attributes must fall within, while cluster 2 304 could include a separate, different threshold that attributes must fall within before they are included. As with other quantities within the communications system 100, each cluster can also be associated with a weighing factor that can be imposed upon the attribute that is selected to represent the cluster—in FIG. 3, attributes A2 and attribute A5.

Furthermore, attributes within a cluster could be identified by the correlation module 156 as having particular characteristics, such as a very high degree of correlatability, in which case it may be appropriate to group the very highly correlated attributes in their own cluster, here attributes A6 and A7 have been removed from cluster 2 304 and placed in cluster 3 308 because of their very high correlatability scores. Should this very high degree of correlatability drop to only being correlated, an evaluation could then be made by the correlation module 156, cooperating with the cluster module 164, as to whether attributes A6 and A7 should be moved back into cluster 2 304, or into some other cluster, or should stand alone.

The historical information regarding which attributes were associated with which clusters can be stored by the cluster module 164 and can be used to assist with future attribute assignment to a cluster. The cluster module 164 could also be associated with a template module (not shown), such that the information regarding which attributes are associated with which cluster could be exported and used, for example, in another contact center.

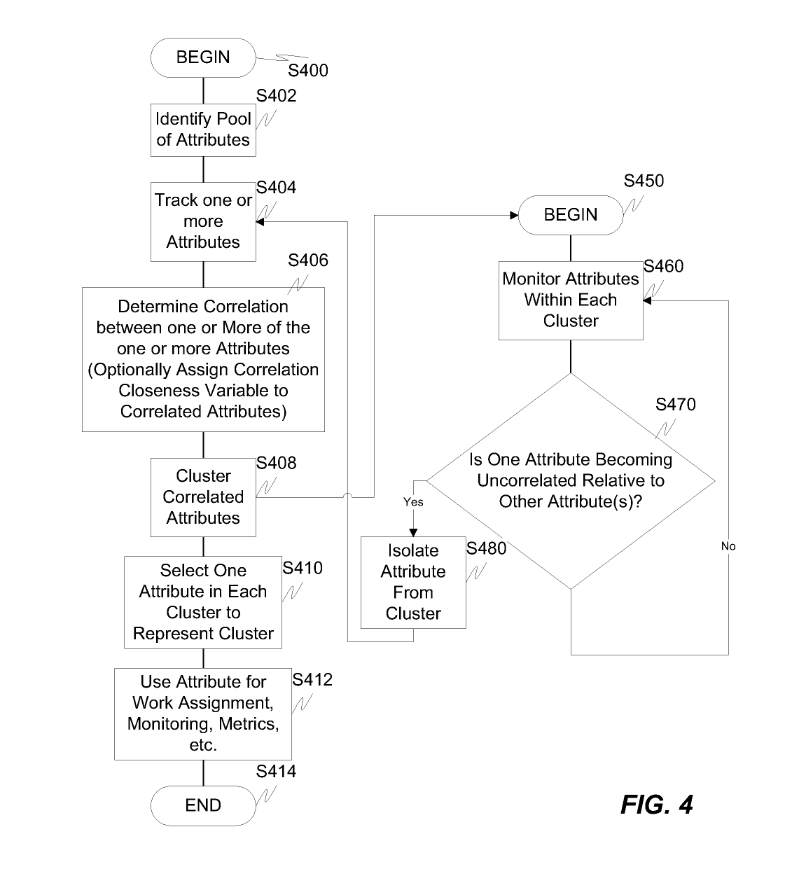

FIG. 4 outlines an exemplary method of operation for creation and management of one or more clusters. In particular, control begins in step S400 and continues to step S402. In step S402, a pool of attributes/factors are identified. Next, in step S404, one or more attributes in the pool of identified attributes are tracked. Next, in step S406, a correlation is determined between one or more of the one or more attributes. Furthermore, a correlation closeness variable can be assigned that represents the relative degree of correlation between a plurality of attributes. Control then continues to step S406.

In step S406, attributes that have a certain degree of correlation are clustered, and the cluster is assigned an identifier. Next, in step S410, one attribute in each cluster is selected to represent the cluster, with an optional scaling or normalizing of that attribute being performed to account for differences in displacement between the clustered attributes. Then, in step S412, the attribute that is selected to represent the cluster can be used for one or more of work assignments, resource management, monitoring, metrics, or in general any characteristic of a communications system environment. Control then continues to step S414 where the control sequence ends.

A sub-process to the clustering of correlated attributes in step 408 begins in step S450. Next, in step S460, one or more of the attributes within each cluster can be monitored to track whether they are remaining correlated with the other attributes included in that cluster. Then, in step S470, a determination can be made as to whether one or more of the attributes that had been previously clustered are becoming uncorrelated relative to one or more of the other attributes. Upon, for example, reaching a threshold degree of uncorrelatedness, control can continue to step S480 where the uncorrelated attribute is isolated from the cluster with control jumping back to step S404. Otherwise, and as discussed, control jumps back to step S460 with the system validates on a certain basis, e.g., time, importance, work load, etc, whether the clustered attributes are remaining correlated in accordance with the set threshold.

It should be appreciated that while embodiments of the present disclosure have been described in connection with a contact center architecture having clustered attributes, embodiments of the present disclosure are not so limited. In particular, those skilled in the contact center arts will appreciate that some or all of the concepts described herein may be utilized in other communications environments where attributes share a correlatedness.

Furthermore, in the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

1. A method for managing attributes in a contact center comprising:
tracking a plurality of attributes in the contact center;
for each of the plurality of attributes determining a relative degree of correlatedness to one or more other attributes; and
based on the relative degree of correlatedness, assigning correlated attributes to a cluster, wherein a strength of the relative degree of correlatedness is varied based on contact center resources.

2. The method of claim 1, further comprising selecting one attribute in the cluster to represent all the attributes in the cluster for one or more of work assignment, resource management and metric computation.

3. The method of claim 1, further comprising removing an attribute from a cluster when the attribute becomes uncorrelated.

4. The method of claim 1, further comprising selecting one attribute in the cluster to represent all the attributes in the cluster for one or more of work assignment, resource management and metric computation and scaling or normalizing the attribute to account for displacement relative to one or more other attributes in a same cluster.

5. The method of claim 1, wherein the contact center environment includes a plurality of clusters and simulation tool that allows measures including predictive accuracy, complexity of a computation and speed of the computation to be approximated as attributes and clusters are added to, or removed from, an equation, wherein the equation is [performance of an aspect of the contact center]=[score on factor A times weighing of factor A]+[score on factor B times weighing of factor B] . . . +[score on factor Z times weighing of factor Z].

6. The method of claim 5, wherein the plurality of clusters have a different number of associated attributes.

7. The method of claim 1, wherein information representing the cluster is exportable into a template.

8. The method of claim 7, wherein the template can be used in another contact center environment, and wherein results of factor analysis are provided back to a vendor of contact center equipment, thereby allowing the vendor to adjust configurations of equipment offered to the contact centers and to other contact centers that support a similar customer bases.

9. The method of claim 1, wherein the relative degree of correlatedness is a range or threshold and the contact center resources include one or more or call volume, computational horsepower, available resources and contact center performance metrics.

10. The method of claim 1, wherein contact center-adjustable correlational cluster analysis techniques reduce a cost, a time, and a computation complexity required to make optimal or close-to-optimal work assignments.

11. A system for managing attributes in a contact center comprising:
a tracking module and processor that track a plurality of attributes and for each of the plurality of attributes determine a relative degree of correlatedness to one or more other attributes; and
a cluster module that, based on a relative degree of correlatedness, assigns correlated attributes to a cluster, wherein a strength of the relative degree of correlatedness is varied based on contact center resources.

12. The system of claim 11, wherein an attribute in the cluster is selected to represent all the attributes in the cluster for one or more of work assignment, resource management and metric computation.

13. The system of claim 11, wherein the cluster module and a correlation module remove an attribute from a cluster when the attribute becomes uncorrelated.

14. The method of claim 11, wherein one attribute in the cluster is selected to represent all the attributes in the cluster for one or more of work assignment, resource management and metric computation and the attribute is scaled or normalized to account for displacement relative to one or more other attributes in a same cluster.

15. The method of claim 11, wherein the contact center environment includes a plurality of clusters and simulation tool that allows measures including predictive accuracy, complexity of a computation and speed of the computation to be approximated as attributes and clusters are added to, or removed from, an equation, wherein the equation is [performance of an aspect of the contact center]=[score on factor A times weighing of factor A]+[score on factor B times weighing of factor B] . . . +[score on factor Z times weighing of factor Z].

16. The method of claim 15, wherein the plurality of clusters have a different number of associated attributes.

17. The method of claim 11, wherein the template can be used in another contact center environment, and wherein results of factor analysis are provided back to a vendor of contact center equipment, thereby allowing the vendor to adjust configurations of equipment offered to the contact centers and to other contact centers that support a similar customer bases.

18. The method of claim 17, wherein the template can be used in another contact center environment.

19. The method of claim 11, wherein the relative degree of correlatedness is a range or threshold and the contact center resources include one or more or call volume, computational horsepower, available resources and contact center performance metrics.

20. The method of claim 11, wherein contact center-adjustable correlational cluster analysis techniques reduce a cost, a time, and a computation complexity required to make optimal or close-to-optimal work assignments.
